(19) United States
(12) Patent Application Publication
(10) Pub. No.: US 2026/0313301 A1
(43) Pub. Date: Oct. 8, 2026

(54) Hearing aid with adaptive level steering

(71) Applicant: Oticon A/S, Smørum (DK)

(72) Inventors: Adel ZAHEDI, Smørum (DK); Yurii IOTOV, Smørum (DK); Mirjana SPASIC, Ballerup (DK)

(21) Appl. No.: 19/565,584

(22) Filed: Mar. 13, 2026

(30) Foreign Application Priority Data
Apr. 4, 2025 (EP) 25168558.2

(51) Int. Cl. H04R 25/00

(52) U.S. Cl. CPC H04R 25/505; H04R 25/554; H04R 25/558; H04R 2225/43; H04R 2225/55; H04R 2430/01

(57) ABSTRACT

Disclosed herein are embodiments of a hearing aid including an input unit, a wireless interface for providing one or more external audio signals, and a processor. The processor can be configured to determine one or more first input levels, determine one or more second input levels, determine one or more first output levels based on the one or more first input levels, determine one or more second output levels based on the one or more second input levels, determine a perceptual measure associated with the one or more external audio signals, determine a first gain correction based on the perceptual measure, and process the one or more input audio signals based on the first gain correction to provide an output signal.

### CROSS REFERENCE TO RELATED APPLICATIONS

Any and all applications for which a foreign or domestic priority claim is identified in the Application Data Sheet as filed with the present application are hereby incorporated by reference under 37 CFR 1.57.

### TECHNICAL FIELD

The present application relates to the field of hearing aids.

### TECHNICAL FIELD

Modern hearing aids are typically able to collect audio input via other paths than microphones associated with the hearing aid. One of the most common alternative paths being streaming audio signal from an external device, such audio signals may be associated with music or other media being played via an external device.

The potential for the presence of multiple input paths brings challenges too, since most hearing aid users tend to focus only on one of the sound sources at any given time, and the rest are normally considered as distraction.

Thus, it is important to make sure the audibility of distracting sounds is reduced while the audibility of a sound of interest is increased or at least maintained.

### SUMMARY

In an aspect of the present application a hearing aid is provided. The hearing aid may comprise an input unit for providing one or more input audio signals representing sound in an environment of the hearing aid. The hearing aid may comprise a wireless interface for providing one or more external audio signals. The hearing aid may comprise a processor. The processor may be configured to determine one or more first input levels based on the one or more input audio signals. The processor may be configured to determine one or more second input levels based on the one or more external audio signals. The processor may be configured to determine one or more first output levels based on the one or more first input levels. The processor may be configured to determine one or more second output levels based on the one or more second input levels. The processor may be configured to determine a perceptual measure associated with the one or more externals audio signals based on the one or more first output levels and the one or more second output levels. The processor may be configured to determine a first gain correction based on the perceptual measure. The processor may be configured to process the one or more input audio signals based on the first gain correction to provide an output signal.

Thereby an improved hearing aid may be provided. The presented solution calculates a perceptual measure using the input and “unadjusted” output levels for a target and a background sound. Based on the resulting score, several action may be taken to produce “adjusted” output levels, e.g., if the background sound is not distracting, based on the perceptual measure, no adjustments is necessary to be applied, if the background sound is likely to interfere with the target, its volume will be reduced to a less disturbing level without overly attenuating it.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a processor for enhancing the input signals and providing a processed output signal.

The hearing aid may comprise an output unit for providing a stimulus perceived by the user as an acoustic signal based on a processed electric signal. The output unit may comprise an output transducer. The output transducer may comprise a receiver (loudspeaker) for providing the stimulus as an acoustic signal to the user (e.g. in an acoustic (air conduction based) hearing aid). The output unit may be configured to output the output signal determined by the processor.

The hearing aid may comprise an input unit for providing an electric input signal representing sound. The input unit may comprise an input transducer, e.g. a microphone, for converting an input sound to an electric input signal. The input unit may be configured to provide one or more input audio signals representing sound in an environment of the hearing aid. The input unit may comprise a plurality of microphones for providing a plurality of input audio signals.

The hearing aid may comprise a wireless interface. The wireless interface may be configured to receive and/or transmit an electromagnetic signal in the radio frequency range (3 kHz to 300 GHz). The wireless interface may be configured to provide one or more external audio signals.

The wireless interface may comprise antenna and transceiver circuitry allowing a wireless link to an entertainment device (e.g. a TV-set), a communication device (e.g. a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by the wireless interface of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aid may comprise a signal path for processing an audio signal between an input and an output of the hearing aid. A processor may be located in the signal path. The processor may be adapted to provide a frequency dependent gain according to a user's particular needs, e.g. hearing impairment. The hearing aid may comprise an analysis path comprising functional components for analyzing signals and/or controlling processing of the signal path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output transducer.

The hearing aid may comprise a hearing instrument, e.g. a hearing instrument adapted for being located at the ear or fully or partially in the ear canal of a user.

The processor may comprise one or more processing units. The processor may be configured to obtain a signal, e.g., an audio signal, a sensor signal, an information signal, and/or a control signal.

The processor may control one or more functionalities of the hearing aid. The user of the hearing aid may provide signals to the processor via an input interface on the hearing aid, or via an app on an auxiliary device communicatively connected to the hearing aid. The processor may be configured to obtain a signal via the input unit. The processor may be configured to obtain a signal via the wireless interface.

The one or more input audio signals may comprise a speech component and a noise component. The speech component may be a part of the one or more input audio signals desired to be amplified to correct for a hearing loss of the hearing aid user, e.g., speech of an interlocutor. The noise component may be part of the one or more input signals desired to be suppressed or reduced, e.g., background noise or interfering speech. The one or more input audio signals may interfere with a target signal, this may especially be the case if the hearing aid user is listening to a streamed audio signal, then the one or more input audio signals may be viewed as an interference. Thus, the one or more input signals may in some cases be a target signals and in others may act as interference. The one or more input signals may be derived from microphone signals obtained by one or more microphones comprised by the hearing aid.

The one or more external audio signals may be a streamed audio signal. The one or more external audio signals may be received from an auxiliary device communicatively connected to the hearing aid. The one or more external audio signals may be a target signal for the hearing user if the hearing user is streaming the one or more external audio signals to the hearing aid. The one or more external audio signals may be associated with music or other media content streamed by the hearing aid user.

The output signal may be a signal to be outputted to the user of the hearing aid. The output signal may be based on processed versions of the one or more input audio signals and the one or more external audio signals. The output signal may be based on a combination of the one or more input audio signals and the one or more external audio signals.

Determining the one or more first input levels, based on the one or more input audio signals, may be carried out by a level unit comprised by the processor. The one or more first input levels may be determined for a plurality of frequency bands, e.g., the one or more input audio signals may be separated into a plurality of frequency bands and for each of the plurality of frequency bands a first input level may be determined. The one or more first input levels may be determined as one or more decibels measures for the one or more input audio signals.

Determining the one or more second input levels, based on the one or more external audio signals, may be carried out by a level unit comprised by the processor. The one or more second input levels may be determined for a plurality of frequency bands, e.g., the one or more external audio signals may be separated into a plurality of frequency bands and for each of the plurality of frequency bands a second input level may be determined. The one or more second input levels may be determined as one or more decibels measures for the one or more external audio signals.

Determining the one or more first output levels, based on the one or more first input levels, may be carried out by determining the one or more first output levels according to a compression curve. The compression curve may be a personalized curve customized to the hearing loss of the hearing aid user. The compression curve may determine a relationship between input and output levels to facilitate an increase in the dynamic range of the hearing aid user. The compression curve may be stored on the hearing aid as a look-up table.

Determining the one or more second output levels, based on the one or more first input levels, may be carried out by determining the one or more second output levels according to a compression curve. The compression curve used for determining the one or more first output levels may be identical or differ from the compression curve used for determining the one or more second output levels.

Determining the one or more first and second output levels may be viewed as a compression scheme facilitating an increase in the dynamic range of the hearing aid user.

The perceptual measure may be viewed as a measure of speech intelligibility of the one or more external audio signals if it was output together with the one or more input audio signals according to the one or more first output levels and the one or more second output levels. The one or more external audio signals may be set as the target when determining the perceptual measure. The perceptual measure may be a speech intelligibility.

The perceptual measure may be determined as a speech intelligibility index (SII). Determining the perceptual measure may comprise obtaining the target and noise levels in sub bands. If the perceptual measure is SII, the SII may be determined as follows:

$$S = {\sum }_{i = 1}^{N} {γ}_{i} {A}_{i}$$

where the summation is performed over all the N sub bands, and Aᵢ and γᵢ are the band audibility and the band importance for subband i, respectively. The band importance coefficients γᵢ may be a set of weights summing to one. The band's importance coefficients determine the relative contribution of each band to the SII score. In calculating the band audibility values may disregard self-speech masking and spread of masking for simplicity. A more accurate implementation of the SII calculations that takes the masking effects into account is possible at the cost of extra complexity. The target and background output levels may be denoted in dB at subband i by Lᵢ^{t} and Lᵢ^{b}, respectively. The target output levels may be the one or more second output levels, and the background levels may be the one or more first output levels. We define:

$${J}_{i} {=}^{Δ} {L}_{i}^{t} - max ( {L}_{i}^{b} , {T}_{i} ) ,$$

where Tᵢ is the hearing aid user's threshold of hearing in quiet, derived from an audiogram of the hearing aid user. The band audibility can then be approximated as:

$${A}_{i} \approx max ( min ( \frac{{J}_{i} + 15}{30} , 1 ) , 0 )$$

substituting the approximation of the band audibility into the equation for SII yields the SII score. Since the observed target and background levels are calculated and updated instantaneously, the resulting SII score can be changing rapidly as a function of time as causing audible artifacts. A more reliable score can be calculated by smoothing the instantaneous score as follows.

$$\overline{S} ( k ) = μ \overline{S} ( k - 1 ) + ( 1 - μ ) S ( k ) ,$$

where S(k) and S̅(k) are the instantaneous and smoothed SII scores at time instant k, respectively, and 0≤μ≤1 is a fixed coefficient inversely related to the time-constant for smoothing.

The processor may determine the first gain correction from a look-up table, e.g., different values or ranges of the perceptual measure may be associated with different first gain correction values. The first gain correction may be determined via a parametric formula utilizing the perceptual measure as an input. The parametric formula may be empirically determined by one or more audio engineers. The first gain correction may be user dependent, i.e., tailored to fit the preference of the user.

The first gain correction may be viewed as a gain to be applied to the one or more input audio signals or signals deriving therefrom which purpose is to improve the perceptual measure associated with the one or more external audio signals. The first gain correction may be viewed as an additional gain to applied besides the gain decided by a compression scheme of the hearing aid.

If a high perceptual measure is determined, i.e., a perceptual measure indicating a high speech intelligibility of the one or more external audio signals, the first gain correction may be determined as a zero gain as no changes are needed. If a low perceptual measure is determined, i.e., a perceptual measure indicating a low speech intelligibility of the one or more external audio signals, the first gain correction may be determined as a non-zero gain as changes are needed. What constitutes a high perceptual measure, and a low perceptual measure may be based on user preference. If a low perceptual measure is determined the first gain correction may be set so to suppress the one or more input audio signals or signals derived from the one or more input audio signals.

An example of how to determine the first gain correction based on the perceptual measure is presented in the following, again SII is used as the perceptual measure. Let us define the target SII S_{T} as the threshold for labelling the background sound as non-disturbing. In other words, when the observed SII is larger than S_{T}, no background level adjustment is needed. Given S̅(k), the observed SII score at time instant k, we define the required SII correction as follows:

$$Δ S ( k ) = max \{ 0 , ρ ( {S}_{T} - \overline{S} ( k ) ) \} ,$$

where 0≤ρ≤1 is a constant determining the correction proportion. Setting ρ=1 (full correction) implies enough background level reduction to remain above the target SII at all times regardless of the circumstances. A ρ value of less than unity (partial correction) allows for better preservation of the dynamics of the background noise while still reducing the noise levels when needed. The value of ρ may be set by a user of the hearing aid based on the preference of the user. The background level adjustment in dB corresponding to ΔS(k) can be calculated using our prior measure of band audibility as follows:

$$Δ {L}^{b} ( k ) \approx - 30 Δ S ( k ) ,$$

where the approximation is due to disregarding the impact of the max(·) and min(·) operators. Combining this with the required SII correction, the following mapping of the observed SII score S̅(k) to the level adjustment ΔL^{b}(k) at any time instant k is obtained:

$$Δ {L}^{b} ( k ) \approx - 30 max \{ 0 , ρ ( {S}_{T} - \overline{S} ( k ) ) \} .$$

Processing the one or more input audio signals to provide the output signal may comprise applying the first gain correction to the one or more input audio signals and/or a processed signal derived from the one or more input audio signals. The output signal may be combination of processed versions of the one or more input audio signals and the one or more external audio signals. The output signal may be a combination of the one or more input audio signals processed according to the first gain correction with the one or more external audio signals. The first gain correction may be applied as an additional gain on-top of a gain determined by a compression scheme of the hearing aid, e.g., first corrected gain=first compression gain+first gain correction. The output signal may be a combination of the one or more input audio signals processed according to the first gain correction with the one or more external audio signals processed according to the second gain correction. The second gain correction may be applied as an additional gain on-top of a gain determined by a compression scheme of the hearing aid, e.g., second corrected gain=second compression gain+second gain correction.

In an embodiment the processor is configured to determine a second gain correction based on the perceptual measure, and process the one or more external audio signals based on the second gain correction to provide the output signal.

Thus, both the one or more input audio signals and the one or more external audio signals or signals derived therefrom may be adjusted to improve speech intelligibility.

The processor may determine the second gain correction from a look-up table, e.g., different values or ranges of the perceptual measure may be associated with different second gain correction values. The second pain value may be determined via a parametric formula utilizing the perceptual measure as an input. The parametric formula may be empirically determined by one or more audio engineers. The second gain correction may be user dependent, i.e., tailored to fit the preference of the user.

The second gain correction may be viewed as a gain to be applied to the one or more external audio signals or signals deriving therefrom which purpose is to improve the perceptual measure associated with the one or more external audio signals.

In an embodiment the processor is configured to determine a loudness based on the one or more first input levels, determine a second gain correction based on the loudness, and process the one or more external audio signals based on the second gain correction to provide the output signal.

In certain situations, for example when the hearing aid user uses an open dome, a significant portion of the ambient sound can directly reach the eardrum through the openings in the dome. Since this component does not go through the hearing aid, it will not affect the SII, and level adjustment calculations described above and cannot be attenuated. This effect can be particularly significant when the hearing loss is mild, and the background noise is very loud. In such cases, it might be desirable to increase the target by a small or moderate amount.

The determined loudness may be determined by estimating a sound level of the one or more input signals. The loudness may be determined in dB. The loudness may be determined by utilizing a loudness model taking into account the hearing loss of the hearing aid user.

For example, the target level adjustment in dB may be defined as follows:

$$Δ {L}^{t} ( k ) = γ ( {Q}_{input}^{b} ( k ) - {Q}_{T} ) ,$$

where ΔL^{t}(k) is the adjustment to the target level and

$${Q}_{input}^{b} ( k )$$

is a measure of loudness for the background sound. Constant Q_{T} is the threshold for loud background noise, and γ(·) is a nonnegative-valued and monotonically increasing function that maps loudness difference to level correction. The measure

$${Q}_{input}^{b} ( k )$$

can be as simple as the level in dB or as complex as a perceived loudness model.

In an embodiment the processor is configured to determine one or more first compression gains based on a hearing loss and the one or more first input levels, and determine the one or more first output levels based on the one or more first compression gains and the one or more first input levels.

The hearing loss may be provided in the form of an audiogram measured on the hearing aid user.

In an embodiment the processor is configured to determine one or more second compression gains based on a hearing loss and the one or more second input levels, and determine the one or more second output levels based on the one or more second compression gains and the one or more second input levels.

In an embodiment the perceptual measure comprises a speech intelligibility index.

Alternatively, or additionally, the perceptual measure may comprise the hearing aid speech perception index (HASPI) and/or the hearing aid speech quality index (HASQI).

In an embodiment the processor is configured to determine a second silence measure based on the one or more second input levels, and determine the perceptual measure based on the second silence measure.

In an embodiment the processor is configured to determine the second silence measure by comparing the one or more one or more second input levels to a second silence threshold.

During the natural pauses of the target signals, the observed levels for the perceptual measure may drop momentarily. Left untreated, this may lead to unrealistic dips in the determination of the perceptual measure. One example of how to address this is to use a silence detector, and to determine the perceptual measure based on the second silence measure.

The second silence measure may be a binary measure, i.e., a measure indicating whether there is silence or not.

One example of implementing the silence detector while utilizing the above presented measure for a smoothed SII may take the following form:

$$\overline{S} ( k ) = \{ \begin{matrix}\overline{S} ( k - 1 ) , & if silence detected \\ μ \overline{S} ( k - 1 ) + ( 1 - μ ) S ( k ) , & otherwise\end{matrix}$$

In other words, during pauses in the target sound, the SII score update will be paused too. The second silence measure may be implemented by comparing input levels for the target sound with a threshold value.

In an embodiment the processor is configured to release the first gain correction from the one or more input audio signal according to a release rate based on the second silence measure.

Thus, if the user pauses the one or more external audio signals there will be a release on the first gain correction, as the hearing aid user might have paused streaming of the one or more external audio signals as the hearing aid user actually wants to hear the environment.

Release of the first gain correction may be understood as the processor over a period of time removing the first gain correction from being applied to the one or more input audio signals or signals derived therefrom.

The release rate may be in the order of one dB per second, or alternatively, the release rate may be set to fully release the first gain correction in the time span of 5 seconds, or 10 seconds. The release rate may be customizable by a user of the hearing aid.

In an embodiment the processor is configured to determine a first silence measure based on the one or more first input levels, and determine the perceptual measure based on the first silence measure.

In an embodiment the processor is configured to determine the first silence measure by comparing the one or more one or more first input levels to a first silence threshold.

If no audio signals are provided the perceptual measure may reach a maximum value, which can make the estimation of the perceptual measure unstable, thus, to overcome this it may be to paused estimating the perceptual measure if a first silence measure is detected as presented above in conjunction to the second silence measure.

In an embodiment the processor is configured to determine the perceptual measure based on a hearing loss.

In an embodiment the processor is configured to obtain an external control signal via the wireless interface, wherein the external control signal indicates a preference of the user of the hearing aid, and determine the first gain correction based on the external control signal.

Thus, the hearing aid user may customize the first gain correction to suit their preference.

The control signal may be provided via an auxiliary device communicatively connected to the hearing aid. The auxiliary device may be provided with an APP allowing the hearing user to control one or more settings of the hearing aid.

An example of a parameter which could be adjusted via the external control signal is the parameter ρ that weighs how much you want to hit the target SII S_{T}. Another parameter which could be controlled by the user is a target perceptual measure, such as a target SII.

In an embodiment the external control signal controls an aggression of the first gain correction.

In an aspect of the present disclosure a hearing aid is provided. The hearing aid may comprise a processor. The processor may be configured to determine one or more first input levels based on the one or more first audio signals. The processor may be configured to determine one or more second input levels based on the one or more second audio signals. The processor may be configured to determine one or more first output levels based on the one or more first input levels. The processor may be configured to determine one or more second output levels based on the one or more second input levels. The processor may be configured to determine a perceptual measure associated with the one or more second audio signals based on the one or more first output levels and the one or more second output levels. The processor may be configured to determine a first gain correction based on the perceptual measure. The processor may be configured to process the one or more first audio signals based on the first gain correction to provide an output signal.

In an aspect a method of operating a hearing is provided by the present disclosure. The method comprises obtaining one or more external audio signals, obtaining one or more input audio signals, determining one or more first input levels based on the one or more input audio signals, determining one or more second input levels based on the one or more external audio signals, determining one or more first output levels based on the one or more first input levels, determining one or more second output levels based on the one or more second input levels, determining a perceptual measure based on the one or more first output levels and the one or more second output levels, determining a first gain correction based on the perceptual measure, and processing the one or more input audio signals based on the first gain correction to provide an output signal.

It is intended that some or all of the features of the device described above, in the ‘detailed description of embodiments’ or in the claims can be combined with embodiments of the method, when appropriately substituted by a corresponding process and vice versa. Embodiments of the method have the same advantages as the corresponding devices.

In an aspect, a hearing system comprising a hearing aid as described above, in the ‘detailed description of embodiments’, and in the claims, and an auxiliary device is moreover provided.

The hearing system may be adapted to establish a communication link between the hearing aid and the auxiliary device to provide that information (e.g. control and status signals, possibly audio signals) can be exchanged or forwarded from one to the other.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g. a binaural hearing aid system.

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, etc. The hearing aid may comprise a single unit or several units communicating (e.g. acoustically, electrically or optically) with each other. The loudspeaker may be arranged in a housing together with other components of the hearing aid or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system) and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing systems or binaural hearing systems may e.g. be used for compensating for a hearing-impaired person's loss of hearing capability, augmenting or protecting a normal-hearing person's hearing capability and/or conveying electronic audio signals to a person. Hearing aids or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

### BRIEF DESCRIPTION OF DRAWINGS

The aspects of the disclosure may be understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 is a block diagram of a hearing aid according to the present disclosure.

FIG. 2 is a flow diagram according to the present disclosure.

FIG. 3 is a flow diagram of an adaptive gain block according to the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

It is intended that the structural features of the devices described above, either in the detailed description and/or in the claims, may be combined with steps of the method, when appropriately substituted by a corresponding process.

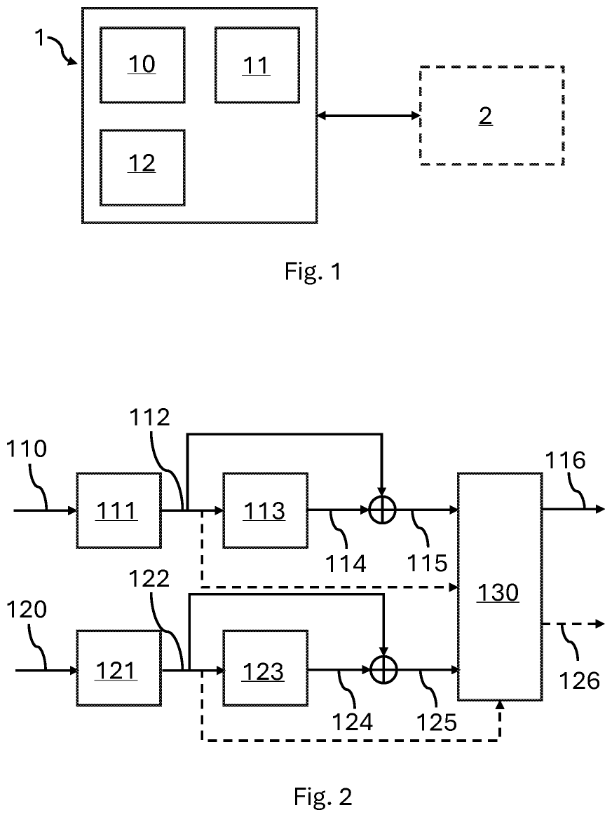

Referring to FIG. 1 showing a block diagram of a hearing aid 1 according to the present disclosure. The hearing aid 1 comprises an input unit 10 configured to provide one or more input audio signals 110 representing sound in an environment of the hearing aid 1. The hearing aid 1 comprises a wireless interface 11 for providing one or more external audio signals 120. The one or more external audio signal 120 may be streamed from an auxiliary device 2 communicatively connected to the hearing aid 1. The hearing aid 1 comprises a processor 12. The processor 12 is configured to determine one or more first input levels 112 based on the one or more input audio signals 110. The processor 12 is configured to determine one or more second input levels 122 based on the one or more external audio signals 120. The processor 12 is configured to determine one or more first output levels 115 based on the one or more first input levels 112. The processor 12 is configured to determine one or more second output levels 125 based on the one or more second input levels 122. The processor 12 is configured to determine a perceptual measure 132 associated with the one or more external audio signals 120 based on the one or more first output levels 112 and the one or more second output levels 122. The processor 12 is configured to determine a first gain correction 116 based on the perceptual measure 132. The processor 12 is configured to process the one or more input audio signals 110 based on the first gain correction 116 to provide an output signal. The processor 12 may be configured to determine a second gain correction 126 based on the perceptual measure 132. The processor 12 may be configured to process the one or more external audio signals 120 based on the second gain correction 126 to provide the output signal. The processor 12 may be configured to determine a loudness 139 based on the one or more first input levels 112. The processor 12 may be configured to determine a second gain correction 126 based on the loudness 139. The processor 12 may be configured to process the one or more external audio signals 120 based on the second gain correction 126 to provide the output signal. The processor 12 may be configured to determine one or more first compression gains based on a hearing loss and the one or more first input levels 112. The processor 12 may be configured to determine the one or more first output levels 115 based on the one or more first compression gains 114 and the one or more first input levels 112. The processor 12 may be configured to determine one or more second compression gains 124 based on a hearing loss and the one or more second input levels 122. The processor 12 may be configured to determine the one or more second output levels 125 based on the one or more second compression gains 124 and the one or more second input levels 122. The perceptual measure may comprise a speech intelligibility index. The processor 12 may be configured to determine a second silence measure 137 based on the one or more second input levels 122. The processor 12 may be configured to determine the perceptual measure 132 based on the second silence measure 137. The processor 12 may be configured to determine the second silence measure 137 by comparing the one or more one or more second input levels 122 to a second silence threshold. The processor 12 may be configured to release the first gain correction from the one or more input audio signal 110 according to a release rate based on the second silence measure 137. The processor 12 may be configured to determine a first silence measure 135 based on the one or more first input levels 112. The processor 12 may be configured to determine the perceptual 132 measure based on the first silence measure 135. The processor 12 may be configured to determine the first silence measure 135 by comparing the one or more one or more first input levels 112 to a first silence threshold. The processor 12 may be configured to determine the perceptual measure 132 based on a hearing loss. The processor 12 may be configured to obtain an external control signal via the wireless interface 11. The external control signal may indicate a preference of the user of the hearing aid 1. The processor 12 may be configured to determine the first gain correction 116 based on the external control signal. The external control signal may control an aggression of the first gain correction 116.

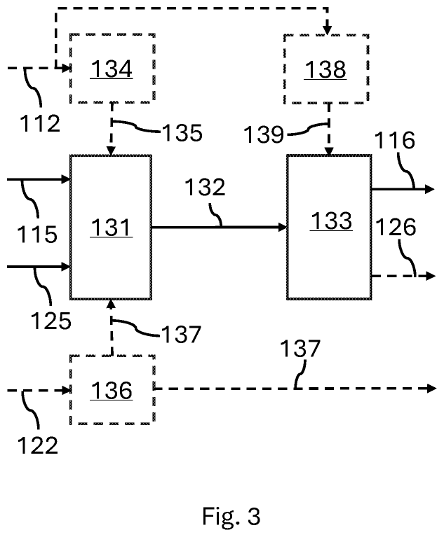

FIG. 2 is a flow diagram according to the present disclosure. The flow diagram depicts how a processor 12 according to the present disclosure handles one or more input audio signals 110 and one or more external audio signals 120. Optional features of the flow diagram are indicated with dashed lines. The one or more input audio signals 110 may be obtained by an input unit 10 of the hearing aid 1, e.g., by one or more microphones comprised by the hearing aid 1. The one or more microphone input audio signals 110 are provided to a first input level detector 111. The first input level detector 111 is configured to receive the one or more input audio 110 signals and determine one or more first input levels 112 of the one or more input audio signals 110. The one or more first input levels 112 may be determined as dB measures within different bands of the one or more input audio signals 110. The one or more first input levels 112 are provided to a first compression gain map 113. The first compression gain map 113 is configured to determine one or more first compression gains 114 based on the one or more first input levels 112. The first compression gain map 113 may comprise a compression scheme for converting the one or more first input levels 112 to the one or more first compression gains 114. The one or more first compression gain 114 are combined with the one or more first input levels 112 to determine one or more first output levels 115. The one or more first output levels 115 are provided to an adaptive level correction block 130. Optionally, the one or more first input levels 112 may be provided to the adaptive level correction block 130. The adaptive level correction block 130 will be described in greater detail in relation to FIG. 3. The one or more external audio signals 120 may be obtained via the wireless interface 11 of the hearing 1. The one or more external audio signals 120 may be audio signals associated with media content being streamed on an auxiliary device 2 communicatively connected to the hearing aid 1. The one or more external audio signals 120 are provided to a second input level detector 121. The second input level detector 121 is configured to receive the one or more external audio signals 120 and determine one or more second input levels 122 of the one or more external audio signals 120. The one or more second input levels 122 may be determined as dB measures within different bands of the one or more external audio signals 120. The one or more second input levels 122 are provided to a second compression gain map 123. The second compression gain map 123 is configured to determine one or more second compression gains 124 based on the one or more second input levels 122. The second compression gain map 123 may comprise a compression scheme for converting the one or more second input levels 122 to the one or more second compression gains 124. The one or more second compression gains 124 are combined with the one or more second input levels 122 to determine one or more second output levels 125. The one or more second output levels 125 are provided to an adaptive level correction block 130. Optionally, the one or more second input levels 122 may be provided to the adaptive level correction block 130.

FIG. 3 is a flow diagram of an adaptive level correction block 30 according to the present disclosure. The adaptive level correction block 130 comprises a perceptual measure block 131. The perceptual measure block 131 is configured to determine a perceptual measure 132 based on the one or more first output levels 115 and the one or more second output levels 125. The perceptual measure 132 may be an SII score determined where the one or more second output levels 125 are viewed as the target and the one or more first output levels 115 are viewed as background noise. The perceptual measure block 136 may obtain a first silence measure 135 determined by a first silence detector 134. The first silence detector 134 may be configured to determine the first silence measure 135 based on the one or more first input levels 112. The first silence measure 135 may be determined by comparing the one or more first input levels 112 to a first silence threshold. The first silence measure 135 may be determined as a flag indicating silence or no silence, e.g., if the one or more first input level does not exceed the first silence threshold the first silence measure may be determined as a flag indicating silence. The perceptual measure block 130 may be configured to pause estimation of the perceptual measure 132 in response to receiving the first silence measure 135, if the first silence measure 135 indicates silence. The perceptual measure block 136 may obtain a second silence measure 137 determined by a second silence detector 136. The second silence detector 136 may be configured to determine the second silence measure 137 based on the one or more second input levels 122. The second silence measure 137 may be determined by comparing the one or more second input levels 122 to a second silence threshold. The second silence measure 137 may be determined as a flag indicating silence or no silence, e.g., if the one or more second input levels 122 does not exceed the second silence threshold the second silence measure 137 may be determined as a flag indicating silence. The perceptual measure block 130 may be configured to pause estimation of the perceptual measure 132 in response to receiving the second silence measure 137, if the second silence measure indicates silence. The perceptual measure 132 is provided to an adaptive gain block 133. The adaptive gain block 133 is configured to determine a first gain correction 116 based on the perceptual measure 132. The adaptive gain block 133 may be configured to determine a second gain correction 126 based on the perceptual measure 132. The adaptive gain block 133 may receive a loudness 139 from a loudness detector 138. The loudness detector 138 is configured to receive the one or more first input levels 112 to determine a loudness 139 of the one or more first input levels 112. The adaptive gain block 132 may be configured to lower the first gain correction 116 in response to the loudness 139 exceeding a loudness threshold. The second silence measure 137 may be sent forward along the processing path to another block to allow for the processor 12 to start releasing the first gain correction in response to the second silence measure 137 indicating silence.

The processor 12 of the hearing aid 1 is configured to determine an output signal by processing the one or more input audio signals 110 based on the first gain correction 116. The processor 12 of the hearing aid 1 may configured to determine an output signal by processing the one or more input audio signals 110 based on the first gain correction 116. The processor 12 may be configured apply the first first gain correction 116 to the one or more input audio signals 110 or processed versions thereof. The processor 12 may be configured to release the first gain correction 116 from the one or more input audio signals 110 or audio signals derived from the one or more input audio signals 110 in response to the second silence measure 137 indicating silence in the one or more external audio signals 120. The processor 12 may release the first gain correction 116 according to a gain release rate.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A hearing aid comprising:
an input unit configured to provide one or more input audio signals representing sound in an environment of the hearing aid,
a wireless interface for providing one or more external audio signals,
a processor configured to:
determine one or more first input levels based on the one or more input audio signals,
determine one or more second input levels based on the one or more external audio signals,
determine one or more first output levels based on the one or more first input levels,
determine one or more second output levels based on the one or more second input levels,
determine a speech intelligibility associated with the one or more external audio signals based on the one or more first output levels and the one or more second output levels,
determine a first gain correction to improve the speech intelligibility of the one or external audio signal based on the determined speech intelligibility, and
process the one or more input audio signals based on the first gain correction to provide an output signal, wherein the output signal is based on the one or more processed input audio signals and the one or more external audio signals.

2. A hearing aid according to claim 1, wherein the processor is configured to:
determine a second gain correction based on the speech intelligibility, and
process the one or more external audio signals based on the second gain correction to provide the output signal, wherein the output signal is based on the one or more processed external audio signals.

3. A hearing aid according to claim 1, wherein the processor is configured to:
determine a loudness based on the one or more first input levels,
determine a second gain correction based on the loudness, and
process the one or more external audio signals based on the second gain correction to provide the output signal.

4. A hearing aid according to claim 1, wherein the processor is configured to:
determine one or more first compression gains based on a hearing loss and the one or more first input levels, and
determine the one or more first output levels based on the one or more first compression gains and the one or more first input levels.

5. A hearing aid according to claim 1, wherein the processor is configured to:
determine one or more second compression gains based on a hearing loss and the one or more second input levels, and
determine the one or more second output levels based on the one or more second compression gains and the one or more second input levels.

6. A hearing aid according to claim 1, wherein the speech intelligibility comprises a speech intelligibility index.

7. A hearing aid according to claim 1, wherein the processor is configured to:
determine a second silence measure based on the one or more second input levels, and
determine the speech intelligibility based on the second silence measure.

8. A hearing aid according to claim 7, wherein the processor is configured to:
determine the second silence measure by comparing the one or more one or more second input levels to a second silence threshold.

9. A hearing aid according to claim 8, wherein the processor is configured to:
release the first gain correction from the one or more input audio signal according to a release rate based on the second silence measure.

10. A hearing aid according to claim 1, wherein the processor is configured to:
determine a first silence measure based on the one or more first input levels, and
determine the speech intelligibility based on the first silence measure.

11. A hearing aid according to claim 10, wherein the processor is configured to:
determine the first silence measure by comparing the one or more one or more first input levels to a first silence threshold.

12. A hearing aid according to claim 1, wherein the processor is configured to:
determine the speech intelligibility based on a hearing loss.

13. A hearing aid according to claim 1, wherein the processor is configured to:
obtain an external control signal via the wireless interface, wherein the external control signal indicates a preference of the user of the hearing aid,
determine the first gain correction based on the external control signal.

14. A hearing aid according to claim 13, wherein the external control signal controls an aggression of the first gain correction.
